(19) United States
(12) Patent Application Publication
(10) Pub. No.: US 2014/0282542 A1
(43) Pub. Date: Sep. 18, 2014

(54) Hypervisor Storage Intercept Method

(71) Applicant: Infinio Systems Inc., Cambridge, MA (US)

(72) Inventors: Peter Smith, New York, NY (US); Devesh Agrawal, Brighton, MA (US)

(21) Appl. No.: 14/210,698

(22) Filed: Mar. 14, 2014

Related U.S. Application Data
(60) Provisional application No. 61/784,346, filed on Mar. 14, 2013.

(51) Int. Cl. G06F 9/455; H04L 12/26

(52) U.S. Cl. CPC G06F 9/45558; H04L 43/0876
USPC 718/1; 709/224

(57) ABSTRACT

Two levels of address masquerading are employed to make a virtual appliance a transparent gateway between a hypervisor and a storage controller. This approach allows a virtual appliance to be inserted or removed from the IP storage path of a hypervisor without disrupting communications. One embodiment of the invention enables a virtual appliance to intercept, manipulate, reprioritize, or otherwise affect IP (Internet Protocol) storage protocols sent or received between a hypervisor and storage controller(s).

This application claims priority of U.S. Provisional Patent Application 61/784,346, filed Mar. 14, 2013, the disclosure of which is incorporated herein by reference in its entirety.

### FIELD OF THE INVENTION

The present disclosure relates to the field of data storage. In particular, it relates to the automatic installation of storage acceleration appliances between a hypervisor and a storage controller.

### BACKGROUND OF THE INVENTION

All computer systems need to provide data storage. As systems enlarged to become networks of work stations, some became data servers provided with data storage facilities that service multiple work stations. As work stations became more sophisticated data servers, they became capable of running multiple implementations of operating systems or multiple instances of a single operating system or combinations of both. Each implementation was a virtual machine requiring connection to one or more storage controllers for the one or more data storage facilities. A hypervisor is a virtual machine manager that creates and runs a virtual machine.

A storage controller is essentially a server responsible for performing functions for the storage system, having an I/O path that communicates to a storage network or directly attached servers and an I/O path that communicates with attached storage devices. It has a processor that handles the movement of data.

In time, storage acceleration appliances were developed, typically as software to increase the efficiency of data storage. Providers of storage acceleration software had to face the problem of integrating that software into the network that connected the data servers with the storage controller without having to shut down the system in order to perform the integration.

A virtual machine is a simulation of a machine usually different from the machine on which it runs. It typically simulates the architecture and function of a physical computer. A storage acceleration appliance is typically apparatus or software designed to deliver high random I/O (Input/Output) performance and low latency access to storage. Latency is a measure of the time delay limiting the maximum rate that information can be transmitted.

The challenge of automated installation of storage acceleration appliances is particularly onerous, as they must be inserted in the active I/O stream between a hypervisor and a centralized storage controller with minimal disturbance of the I/O stream.

One method for providing installation is “inlining”. Inlining is providing control directly in the code for a function rather than transferring control by a branch or call to the code. The process of inlining is historically satisfied by altering the topology of a storage network.

Typically, a device driver is interposed in the operating system of a computer between its kernel and one or more peripheral storage unit device drivers. The device driver intercepts I/O commands, for example synchronous write commands from the operating system that are intended for one of the peripheral storage unit device drivers, and subsequently copies the data specified in a write command to the stable storage of an acceleration device. Alternatively, the storage accelerator is mounted as a distinct storage device, which necessitates that data be migrated to the accelerated storage. Finally, some installations require that every virtual machine run a proprietary plugin that redirects storage requests to their acceleration appliance.

It would be beneficial if there were a software program and method of installing that program that allows a storage acceleration appliance to be added to a computer system with minimal disturbance to that system's operation. For example, it would be advantageous if the software program could be loaded without interrupting the operation of the computer system.

### SUMMARY

The present invention enables an Internet download distribution channel for delivering storage acceleration software to prospective users that may be installed and/or removed while appearing transparent, i.e. not disturbing I/O processes. An intuitive, automated, and non-disruptive installation process aids this self-service approach. The technique inserts a virtual appliance in the active I/O stream between a hypervisor and storage controller without interrupting data transmission or requiring physical topology changes.

One embodiment of the invention enables a virtual appliance to intercept, manipulate, reprioritize, or otherwise affect IP (Internet Protocol) storage protocols sent or received between a hypervisor and storage controller(s).

The virtual appliance is able to masquerade as the targeted storage controller causing the virtual appliance to receive storage requests from the hypervisor that would otherwise have been sent directly to the storage controller. A second level of redirection ensures that responses from the storage controller are redirected to the virtual appliance. The virtual appliance captures responses from the storage controller by masquerading as the storage interface of the hypervisor.

Two levels of address masquerading are employed to make the virtual appliance a transparent gateway between the hypervisor and the storage controller. This approach allows a virtual appliance to be inserted or removed from the IP storage path of a hypervisor without disrupting communications.

The two levels of address masquerading are accomplished by inserting a virtual appliance, termed a storage intercept virtual machine (SIVM), within a virtual switch (vSwitch) between a private VLAN and a public VLAN that interfaces the Network Interface Card (NIC) which is itself the interface to the physical network leading to the network's data storage devices. The SIVM has its own virtual NICs which it uses to handle the intercepted I/O stream.

### BRIEF DESCRIPTION OF THE FIGURES

For a better understanding of the present disclosure, reference is made to the accompanying drawings, which are incorporated herein by reference and in which:

FIG. 1 depicts a data network 100 prior to installation of an embodiment of the present invention;

FIG. 2 is a first embodiment of the storage intercept virtual machine;

FIG. 3 is a expanded view of the storage intercept of FIGS. 2; and

FIG. 4 shows various software components in the storage intercept virtual machine.

### DETAILED DESCRIPTION

FIG. 1 depicts a data network 100 prior to installation of an embodiment of the present invention. In FIG. 1, multiple physical servers 102 are connected by a network 104 to a data storage unit 106. A physical server 102 comprises one or more central processing units, and associated memory devices. The memory devices are used to store data and instructions used by the central processing units. The memory devices are non-transitory media and may be electronic memory devices, such as read only memories (ROM) or random access memory (RAM). These two types of memories may be made employing various technologies, including, but not limited to DRAM, Flash, EEROM, and others. The memory devices may also be optical devices, such as CDROMs or DVDROMs. Similarly, the memory devices may be magnetic storage, such as disk drives. The type of technology used to create the memory devices is not limited by this disclosure. A typical physical server 102 is commercially available from a number of suppliers. One such physical server is an HP DL360 G7 with a built-in NIC.

A typical data storage unit 106 is attached to the system through the use of a storage controller 120. A storage controller 120 is a specialized type of computer system, which includes specialized software allowing it to operate as a data storage controller. In some embodiments, a generic physical server, like those described above, is modified to include this specialized software and is in electrical communication with a large amount of disk storage, forming the data storage unit 106. In other embodiments, a dedicated data storage unit, which includes both the storage controller 120 and the data storage unit 106 may be used. One such device is the NetApp FAS 2240. Like the physical servers 102, the storage controller 120 includes one or more central processing units, associated memory devices, and one or more network connections, in the form of NICs.

Although only two physical servers 102 and a single data storage unit 106 are shown, it should be understood that the invention applies to any number of each type of device. As described above, each physical server has central processing units capable of executing instructions disposed within memory devices located within, or electrically accessible to, the central processing units. Each physical server 102 may implement one or more virtual machines 108, and contain a hypervisor 110, which is the main operating system of the servers. A virtual machine 108 is a software program, comprising instructions disposed on the memory devices, which when executed by the central processing units, simulates a computer system. Multiple instantiations of the virtual machine 108 may be executing concurrently, each representing a virtual computer system represented by software. Similarly, the hypervisor 110 is a software program, which, when executed, is the operating system of the physical server 102. As such, it typically controls the physical hardware of the physical server 102. For example, all of the virtual machines 108 communicate to the hypervisor 110 to access the data storage unit 106 or the NIC 112. The hypervisor 110 comprises a plurality of software components, including a software-based storage client, also referred to as a datastore 114, and a virtual storage interface to the datastore 114, also referred to as a virtual machine kernel interface 116. The hypervisor 110 governs communication with the physical network 104 through the network interface card (NIC) 112. The communication between the virtual machine kernel interface 116 and the NIC 112 is via a public virtual LAN 118 mediated by a virtual switch 122. The virtual switch 122 is a software representation of a traditional network switch and may be used to network the various virtual machines 108 resident in the physical server 102. In addition, it is used to route storage requests between a particular virtual machine 108 and the data storage unit 106. The public virtual LAN 118 is so named because it is accessible to all of the virtual machines 108 in the data network 100, as well as to all of the storage controllers.

As shown in FIG. 2, one embodiment 200 of the storage intercept virtual machine (SIVM) places the virtual machine kernel interface(s) 202 of the hypervisor 204 in a private virtual network 206. The private virtual network 206 is established by assigning an unused VLAN ID (Virtual Local Area Network) to the storage interface(s) 202 of the hypervisor 204. The selected VLAN ID must not be used on the physical network 208, as VLAN communications must be private to a virtual switch 220 within the hypervisor 204. With this change, the storage interface 202 of the hypervisor 204 is completely isolated from the public VLAN 214 and the public storage network 208. A gateway, also referred to as the SIVM 300, is necessary to enable communications between the storage interface 202 of the hypervisor 204 and that of the storage controller 212.

As shown in FIG. 3, a virtual SIVM appliance 300 is introduced to support the gateway function. The virtual appliance 300 has two virtual network interface cards (VNICs), one VNIC 302 attached to the newly created private virtual network 206 and a second virtual NIC 306 attached to the public virtual network 214. As shown in FIGS. 1 and 2, the virtual public network 214 is then attached to the physical storage network 208 via a NIC. This multi-homed virtual appliance 300 is now situated in the vSwitch topology to function as a gateway; however, additional capabilities are needed to cause traffic to pass through the virtual appliance 300.

In some embodiments, the virtual appliance 300 captures traffic by issuing ARP (Address Resolution Protocol) responses that resolve select IP addresses to the MAC (Media Access Control) address of the virtual appliance 300. This mechanism works because the storage interface 202 of the hypervisor 204 is isolated from receiving ARP responses from the storage controller 212 on the public network 208; similarly, the storage controller 212 is isolated from receiving ARP responses from the hypervisor 204 on the private virtual network 206. The virtual appliance 300 is therefore able to issue Proxy ARP responses to the storage interface 202 of the hypervisor 204 that resolve the IP address of the storage controller 212 to the MAC address of the virtual appliance 300. Likewise, the storage controller 212 receives Proxy ARP responses from the virtual appliance 300 that resolve the IP address of the hypervisor 204 to the MAC address of the virtual appliance 300. In other words, the storage controller 212 uses the MAC address of the virtual appliance 300, for transactions intended for the hypervisor 204. Similarly, the hypervisor 204 uses the MAC address of the virtual appliance 300 for transactions intended for the storage controller 212. In this way, all traffic between the hypervisor 204 and the storage controller 212 necessarily passes through the virtual appliance 300.

In other embodiments, the virtual appliance 300 captures traffic by configuring the MAC address of its network interface 302 on the private virtual network 206 to be the same as the MAC address of the storage controller 212, and by configuring the MAC address of its network interface 306 on the public virtual network 214 to be the same as the MAC address of the virtual machine kernel interface 202. The configuration of the virtual appliance 300 ensures that the MAC address of the private network interface 302 is not visible on the public virtual network 214, and that the MAC address of the public network interface 306 is not visible on the private virtual network 206. By masquerading the MAC addresses in this way, all traffic between the virtual machine kernel interface 202 and the storage controller 212 necessarily passes through the virtual appliance 300.

Although storage traffic is being redirected to the virtual appliance 300, an additional mechanism is provided that allows the software to capture storage traffic as it passes through the gateway.

In some embodiments, the virtual appliance 300 is disposed in a Linux environment. As such, the virtual appliance 300 may utilize standard components that are part of the Linux operating system. FIG. 4 shows some of the components of the virtual appliance 300. A NetFilter 414 provides hook handling within the Linux kernel for intercepting and manipulating network packets. NetFilters is a set of hooks within Linux that allows kernel modules to register callback functions with the network stack. The virtual appliance 300 leverages NetFilters 414 to uniquely mark packets containing storage requests and subsequently redirects them to the TCP port used by the transparent NFS Proxy Daemon 418, also referred to as the engine of the present disclosure. A TPROXY (transparent proxy) performs IP-level (OSI Layer 3) transparent interception and spoofing of outbound traffic, hiding the proxy IP address from other network devices. The TPROXY feature of NetFilters 414 is used to preserve the original packet headers during the redirection process. As packets exit the NetFilters stack, they enter the TCP/IP routing stack, which uses fwmark-based policy routing to select an alternate routing table for all marked packets. Non-marked packets are routed through the virtual appliance 300 via the main routing table 416, while marked packets are routed via an alternate table to the appropriate interface on which the disclosed engine 418 listens.

In some embodiments, the disclosed engine (or transparent NFS proxy daemon) 418 listens to this redirected traffic by creating a socket using the IP TRANSPARENT option, allowing the engine 418 to bind to the IP address of the storage controller 212, despite the address not being local to the virtual appliance 300. In other embodiments, the disclosed engine 418 listens on a plurality of network interfaces within the SIVM 300, each of which is dedicated to handling the storage traffic on behalf of one of a plurality of virtual machine kernel interfaces 202, the network interfaces and virtual machine kernel interfaces being in a one-to-one relationship.

The disclosed engine (or transparent NFS proxy daemon) 418 also establishes a distinct connection to the storage controller 212, which masquerades as having originated from the hypervisor 204; the same process is used to establish such a connection from the SIVM 300. Packets originating from the SIVM 300 are routed based on the main routing table, which is populated with entries that direct packets to the appropriate virtual NIC of the SIVM 300.

In operation, the virtual appliance 300 has two network interfaces (Private VLAN 302, and Public VLAN 306), which are connected to the private (P) 206 and public (S) 214 virtual networks, respectively.

The private virtual network (P network) only contains one host, the hypervisor's storage interface 202, while the public virtual network contains many hosts, including the storage controller 212. When the virtual appliance 300 receives an ARP lookup from the hypervisor 204 on interface 302, it repeats the request on the public virtual network 214 using interface 306. If an ARP response is received from network 214 on interface 306, the virtual appliance 300 issues an ARP response on the private virtual network 206 using interface 302 that maps the IP lookup to the MAC address of interface 302. By using its own MAC address in the ARP response, the virtual appliance 300 is forcing communications from the hypervisor 204 to pass through the virtual appliance 300 via interface 302 in order to reach a host on the network 208. When similar ARP requests are received from the public virtual network 214 over interface 306, the same algorithm is used, albeit reversed. Any ARP lookup originating from the public virtual network 214 that aims to resolve the IP address of the hypervisor 204 will result in the issuance of an ARP response from interface 306 mapping the address of the hypervisor to the MAC address of interface 306.

Details of the processes of the virtual appliance 300 are shown in FIG. 4. In particular, the public virtual network 214 interfaces the virtual appliance 300 with the public storage array 212 via a public interface 306 communicating over the public network 208 with a storage interface 440 of the storage controller 212. The private virtual network 206 interfaces the virtual appliance 300 with the storage interface 202 of the hypervisor 204 and the private interface 302 of the virtual appliance 300. The steps performed by the virtual appliance 300 are shown in FIG. 4. The Proxy ARP Daemon 410 resolves ARP requests to MAC addresses of the adjacent VM interface, effectively bridging the IP space of two VLANs, and updates ARP tables and main routing tables with the learned information. The ARP table 412 is populated by the Proxy ARP Daemon 410. A NetFilter 414 marks NFS packets and forwards NFS packets to the NFS Proxy Daemon port without modifying the packet header. A TPROXY routing table 416 routes marked packets to a loopback device for TPROXY handling. A Transparent NFS Proxy Daemon 418 utilizes an IP TRANSPARENT option to bind a socket to a nonlocal address and manipulates NFS while preserving NFS handle values. A Main Routing Table 420 is populated by a Proxy ARP Daemon 410.

Once the virtual appliance 300 has been inserted as described above, it can be used to implement various functions. For example, it may be used to implement a local cache for all virtual machines resident in the physical server 102. In an embodiment, it may be used to de-duplicate data that is stored in the data storage unit 106. In other embodiments, it can be used to perform other functions related to the organization or acceleration of storage in a data network 100.

Having described the operation of the virtual appliance, its installation into an already operational physical server 102 will be described. As described earlier, one or more virtual machines are already resident in the physical server 102, and are already interacting with the data storage unit 106. The software that comprises the virtual appliance may be loaded on the physical server 102, such as by downloading from the internet, or copied from another media source, such as a CDROM. When executed, the installation software inventories all datastores and vSwitches in the environment to identify the network path to storage. It then deploys the virtual appliance 300 on the physical server 102.

The installation software creates a first VM port group with a VLAN ID that does not conflict with other identifiers in the virtual environment, thus establishing the private VLAN 206. The installation software then overrides the NIC teaming policy of the first VM port group to set all physical NICs (pNICs) to disabled status. This procedure ensures that network communication on the private VLAN does not leak onto the broader physical network 104.

The installation software creates a second VM port group with the same VLAN ID as that used by the virtual machine kernel interface 202 to access the storage controller 212 via the public VLAN 118. The installation software then mirrors the NIC teaming policy of the virtual machine kernel interface 116 to that of the second VM port group.

The installation software connects the first vNIC 302 of the virtual appliance 300 to the first VM port group, corresponding to the private VLAN 206, and connects the second vNIC 306 of the virtual appliance to the second VM port group, corresponding to the public VLAN 214. The installation software also informs the virtual appliance 300 of the IP addresses of the virtual machine kernel interface 202 and the storage controller 212, both of which the virtual appliance will later masquerade.

The virtual appliance 300 begins listening in promiscuous mode for incoming packets on the private vNIC 302. The first packet received on the private VLAN 206 will trigger the beginning of the virtual appliance's intercept routine. At this point, however, no packets are yet flowing on the private VLAN 206.

The installation software changes the VLAN ID of the virtual machine kernel interface 202 to the VLAN ID of the private VLAN 206, and also changes the NIC teaming policy of the virtual machine kernel interface 202 to disable all pNICs. This latter step ensures that communication on the private VLAN 206 does not leak onto the broader physical network 104. As a result of the VLAN ID change, network traffic from the virtual machine kernel interface 202 flows onto the private VLAN 206. The first packet from the virtual machine kernel interface to enter the private VLAN 206 is seen by the virtual appliance because it is listening in promiscuous mode on the private vNIC 302. Detection of this first packet causes the virtual appliance to issue a gratuitous ARP to the virtual machine kernel interface. This gratuitous ARP causes the virtual machine kernel interface to change its IP-to-MAC-address mapping such that the IP address of the storage controller 212 maps to the MAC address of the private vNIC 302 of the virtual appliance, thus forcing traffic directed to the storage controller 212 to flow to the virtual appliance 300 instead.

The act of changing the VLAN ID of the virtual machine kernel interface 202 to the VLAN ID of the private VLAN 206 abruptly terminates the old TCP connection between the virtual machine kernel interface 202 and the storage controller 212. As a result, the hypervisor 204 attempts to reconnect to the storage controller 212. Because of the previous changes, the network packets associated with the reconnection are intercepted by the virtual appliance 300, and the virtual appliance 300 then ensures that the connection is established with the transparent NFS proxy daemon 418 as the endpoint rather than the storage controller 212. The virtual appliance then establishes a new connection from the transparent NFS proxy daemon 418 to the storage controller 212 while masquerading as the IP address of the intercepted virtual machine kernel interface 202. This completes installation.

The process of removing the virtual appliance from the intercepted I/O stream simply reverts the VLAN ID and NIC teaming policy of the virtual machine kernel interface 202 back to the previous configuration, which causes storage traffic to be routed directly to the storage controller 212. The vNICs 302 and 306 remain connected. The virtual appliance issues gratuitous ARPs to the public VLAN 214 to expedite the reassociation of the IP-to-MAC-address mappings to the pre-installation state.

Although the invention has been described in particular embodiments, a person of skill in the art will recognize variations that come within the scope of the invention.

What is claimed is:

1. A software program for use in a data network, said data network comprising at least one server having a central processing unit executing instructions which create a plurality of virtual machines and a hypervisor, said data network further comprising a storage controller, and a physical network connecting the server and the storage controller, said software program comprising a non-transitory media having instructions, which, when executed by said central processing unit, creates a virtual appliance in an active I/O stream between said hypervisor and said storage controller, said virtual appliance adapted to:
masquerade as a targeted storage controller, causing the virtual appliance to receive storage requests from the hypervisor that would otherwise have been sent directly to the storage controller, and
masquerade as the storage interface of the hypervisor to capture responses from the storage controller.

2. The software of claim 1, wherein two levels of address masquerading are accomplished by inserting said virtual appliance between a vSwitch disposed in a private VLAN and a public VLAN, wherein said public VLAN interfaces to a Network Interface Card (NIC).

3. The software of claim 1, wherein said virtual appliance manipulates, reprioritizes, or otherwise handles the intercepted I/O stream.

4. The software of claim 1, wherein a storage interface of said hypervisor comprises a MAC address, said MAC address known only to said virtual appliance.

5. The software of claim 1, wherein said virtual appliance comprises two network interfaces, each with its own IP address, wherein said hypervisor uses a first of said IP addresses when accessing the storage controller, and the storage controller uses a second of said IP addresses when accessing said hypervisor.

6. The software of claim 1, wherein said appliance modifies said storage requests from said hypervisor, and then transmits said modified storage requests to said storage controller, and wherein said storage controller sends responses to said modified storage requests.

7. A method of intercepting communications between a hypervisor and a storage controller, comprising:
inserting a virtual appliance between the hypervisor and the storage controller;
using said virtual appliance to masquerade as said storage controller to said hypervisor such that communications from said hypervisor to said storage controller are routed to said virtual appliance; and
using said virtual appliance to masquerade as said hypervisor to said storage controller such that communications from said storage controller to said hypervisor are routed to said virtual appliance.

8. The method of claim 7, further comprising creating a private virtual network between said virtual appliance and said hypervisor, wherein an interface of said hypervisor and a first interface of said virtual appliance comprise nodes on said private virtual network.

9. The method of claim 8, further comprising disposing a second interface of said virtual appliance on a public virtual network, wherein said second interface of said virtual appliance and an interface of said storage controller comprise nodes on said public virtual network.

10. The method of claim 9, further comprising establishing a first IP-to-MAC-address mapping on said hypervisor and a second IP-to-MAC-address mapping on said storage controller.

11. A software program for intercepting IP communications between a server and a storage controller, said software program comprising a non-transitory media having instructions, which, when executed by a central processing unit, creates:
at least two network interfaces, each having a MAC address;
a mapping between IP addresses and MAC addresses, wherein IP addresses of said server and said storage controller are each mapped to a respective one of said two MAC addresses; and
an engine that monitors communications arriving on each of said network interfaces, and manipulates said communications between said server and said storage controller.

12. The software program of claim 11, wherein said media is disposed in said server.

13. The software program of claim 11, wherein said engine de-duplicates data stored in a data storage unit in communication with said storage controller.

14. The software program of claim 11, wherein said engine implements a local cache of data for said server.
